(19) United States
(12) Patent Application Publication
(10) Pub. No.: US 2019/0303170 A1
(43) Pub. Date: Oct. 3, 2019

(54) SYSTEMS AND METHODS FOR INITIALIZING COMPUTING DEVICE BUS LANES DURING BOOT

(71) Applicant: Lenovo Enterprise Solutions (Singapore) Pte. Ltd., New Tech Park (SG)

(72) Inventors: Patrick Leo Caporale, Raleigh, NC (US); Christopher Stephen Floyd, Raleigh, NC (US); Brian Ross Fuchs, Raleigh, NC (US); Steven John Livaccari, Raleigh, NC (US); Joshua D. Lowry, Raleigh, NC (US)

(21) Appl. No.: 15/941,100

(22) Filed: Mar. 30, 2018

(51) Int. Cl. G06F 9/4401; G06F 13/40; G06F 13/16

(52) U.S. Cl. CPC G06F 9/4411; G06F 2213/0026; G06F 13/1668; G06F 13/4068

(57) ABSTRACT

Systems and methods for initializing computing device bus lanes during boot are disclosed. According to an aspect, a method may be implemented at a processing module configured to operate when a computing device is not booted. The method includes determining, prior to the computing device being booted, a number of lanes for communication via a bus by the computing device. The method also includes initializing, during boot of the computing device, the lanes of the bus according to the determined number of lanes.

### TECHNICAL FIELD

The presently disclosed subject matter relates to computing device resource allocation. More particularly, the presently disclosed subject matter relates to systems and methods for initializing computing device bus lanes during boot.

### BACKGROUND

In computer systems, a bus is a communication system that transfers data between components of a computing device. A local input/output (I/O) bus transfers data between a peripheral component and a computing device. Various types of I/O buses include peripheral components interconnect (PCI), accelerated graphics port (AGP), industry standard architecture (ISA), universal serial bus (USB), micro channel architecture (MCA), enhanced ISA (EISA), and video electronics standards association (VESA).

A PCI express (PCIe) bus is an implementation of a PCI computer bus according to a set of specifications promulgated by the PCI Special Interest Group. The PCIe bus uses PCI programming and software concepts, but is based on serial bus architecture as opposed to the parallel bus architecture of the conventional PCI. This physical layer of the PCIe computer bus includes a network of serial interconnections extending from a PCI host bridge or a switch to each peripheral component, which may be referred to as an adapter. A connection between the host bridge or the switch to an adapter is referred to as a “link”. The link includes a collection of one or more lanes used for data communication. Each lane is a set of two unidirectional low voltage differential signaling pairs of transmission pathways such as, for example, traces along a motherboard. Since transmitting data and receiving data are implemented using separate differential pairs, each lane allows for full-duplex serial data communication.

The number of lanes used for communication is fixed at boot time. This requires the maximum number of lanes for a device to be instantiated at boot and remain active. Rebooting the computing device to reallocate the lanes can require a significant amount of time, particularly in server environments. Examples include a PCIe bus training and a network serializer/deseriealizer (SerDes) based port. Each of these examples may provide a x4 or x8 type of connection between two endpoints, and is negotiated to the maximum supported bandwidth on system start.

In view of the foregoing, there is a need for improved systems and techniques for managing computing bus lanes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for initializing computing device bus lanes during boot. According to an aspect, a method may be implemented at a processing module configured to operate when a computing device is not booted. The method includes determining, prior to the computing device being booted, a number of lanes for communication via a bus by the computing device. The method also includes initializing, during boot of the computing device, the lanes of the bus according to the determined number of lanes.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings example embodiments; however, the presently disclosed subject matter is not limited to the specific methods and instrumentalities disclosed. In the drawings:

FIG. 1 is a block diagram of an example system including a resource allocation module configured to initialize computing device bus lanes during boot in accordance with embodiments of the present disclosure;

FIG. 2 is a block diagram showing an example PCIe bus including multiple lanes connecting a processor and a computing device component in accordance with embodiments of the present disclosure;

FIG. 3 is an example flow chart of an example method for initializing computing device bus lanes during boot in accordance with embodiments of the present disclosure; and

FIG. 4 is a flow chart of another example method for initializing computing device bus lanes during boot in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device may be a server or any other type of computing device. For example, a computing device can be any type of conventional computer such as a laptop computer or a tablet computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. In another example, the user can use any other suitable user interface of a computing device, such as a keypad, to select the display icon or display object. For example, the user can use a track ball or arrow keys for moving a cursor to highlight and select the display object.

As used herein, the term “memory” is generally a storage device of a computing device. Examples include, but are not limited to, Read Only Memory (ROM), Random Access Memory (RAM), or Non-Volatile Random Access Memory (NVRAM).

As used herein, the term “bus adapter” is generally an electronic device configured to connect a components of computing device to a bus so that data may be transferred between the components via the bus. More generally, an adapter may be any electronic device that connects a component to another component.

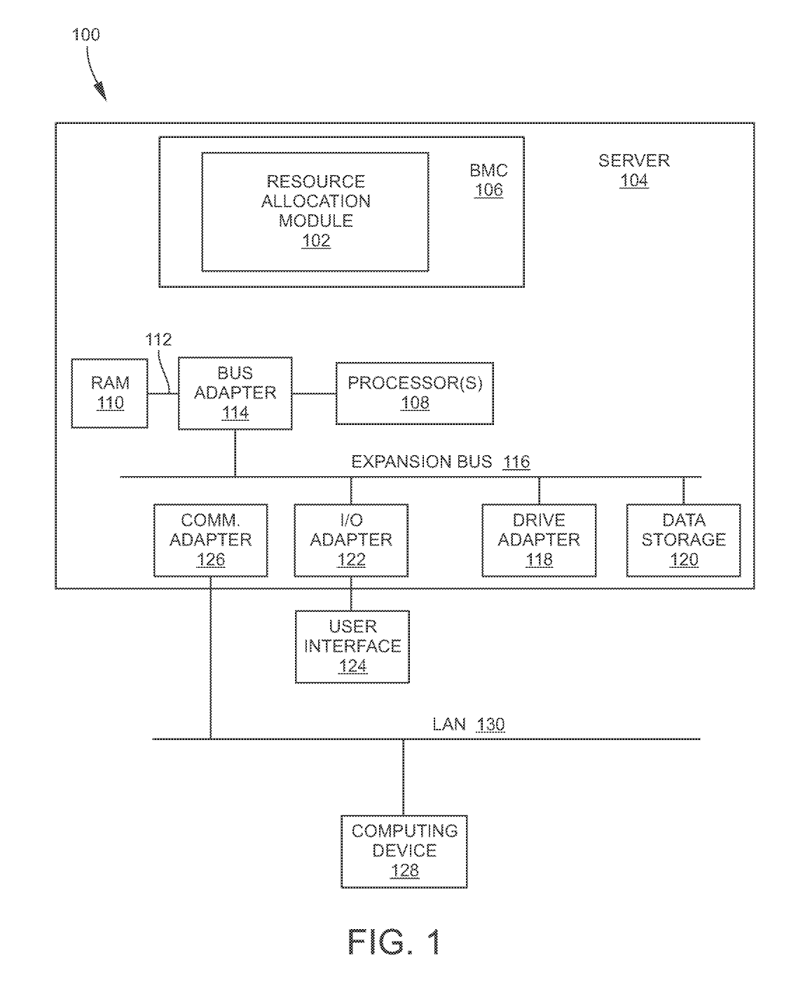

FIG. 1 illustrates a block diagram of an example system 100 including a resource allocation module 102 configured to initialize computing device bus lanes during boot in accordance with embodiments of the present disclosure. In this example, the resource allocation module 102 is shown as being implemented on a server 104, but it should be understood that the resource allocation module 102 may be implemented on any suitable computing device. In this example, the resource allocation module 102 may be implemented by a suitably configured baseboard management controller (BMC) 106 or any other suitable processing module configured to operate when the server 104 is not booted. Referring to FIG. 1, the server 104 includes one or more processors 108 and random access memory (RAM) 110 which may be connected together through a high speed memory bus 112 and bus adapter 114 to processor(s) 108 and to other components of the server 104.

The server 104 includes an expansion bus 116. In this example, the expansion bus 116 is a PCIe bus but may alternatively be any other suitable type of bus. The expansion bus 116 may include shared lines such that a PCI host and a connected device each share a common set of address/data/signal lines. The expansion bus 116 may include multiple lanes. Each lane may include two differential signaling pairs. The first differential signaling pair can be configured to receive data, while the other differential signaling pair can be configured to transmit data. Each lane may include four wires or signal traces.

The lanes of a PCIe bus can each provide bandwidth to a device that is connected to the PCIe bus. As such, low-speed peripherals such as an 802.11 Wi-Fi adapter may utilize fewer lanes, which high-speed peripherals such as a graphics adapter may utilize more lanes. Thus, the PCIe bus represents a flexible interconnect between devices, such as a processor and a peripheral device, as the PCIe bus can couple devices that require varying bandwidths. The number of lanes utilized to facilitate data communications between two devices can be expressed with an “x” prefix, such that x16 represents a sixteen lane connection, which x2 represents a two lane connection.

RAM 110 may store an operating system for managing hardware, software, and other resources of the server 104. The operating system may also provide various services for computer programs residing on the server 104.

The server 104 includes a disk drive adapter 118 operatively connected through expansion bus 116 and bus adapter 114 to the processor(s) 108 and other components of the server 104. Disk drive adapter 114 can connect non-volatile data storage, such as disk drive 120, to the server 104. The server 104 may include one or more I/O adapters 122. I/O adapters 122 may implement user-oriented input/output through, for example, software drivers and computer hardware for controlling output to displays, as well as user input from user interfaces 124, such as keyboards, mice, and the like.

The server 104 may include a communications adapter 126 for data communications with other servers or computing devices, such as computing device 128. The communications adapter 126 may also provide for data communications with network switches, routers, and the like. The communications adapter 126 may also provide for data communications with a communications network 130. Such data communications may be conducted serially through RS-232 connections, through external buses such as a universal serial bus (USB), through data communications networks such as IP data communications networks, and the like. Communications adapters can implement the hardware level of data communications through which one computing devices sends data to another computing device, directly or through a communications network. Example adapters that can allocate lanes in a bus include modems for wired dial-up communications, Ethernet adapters for wired data network communications, and 802.11 adapters for wireless data network communications.

In accordance with embodiments, the resource allocation module 102 may be implemented by the BMC 106 or another other component configured to operate when a computing device is not booted. The resource allocation module 102 may be implemented by any suitable hardware, software, firmware, or combinations thereof. In embodiments, the resource allocation module 102 may be configured to determine, prior to the server 104 being booted, a number of lanes for communication via the expansion bus 116. During boot of the server 104, the resource allocation module 102 may initialize lanes of the bus according to the determined number of lanes.

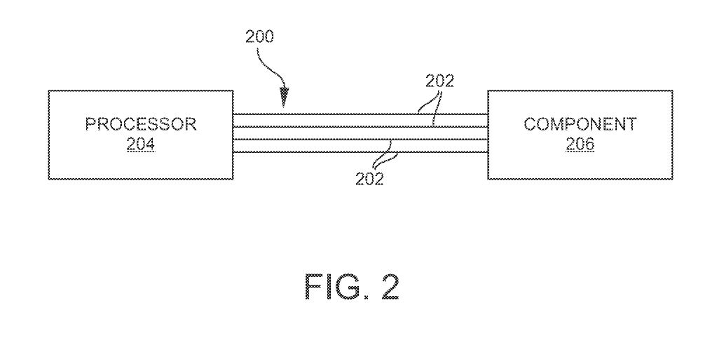

FIG. 2 illustrates a block diagram showing an example PCIe bus 200 including multiple lanes 202 connecting a processor 204 and a computing device component 206 in accordance with embodiments of the present disclosure. It should be understood that the bus 200 may alternatively be any other suitable type of bus configured to have multiple lanes between components. Each lane 202 may include two differential signaling pairs. The first differential signaling pair may receive data, while the other differential signaling pair may transmit data. Each lane 202 may include four wires or signal traces.

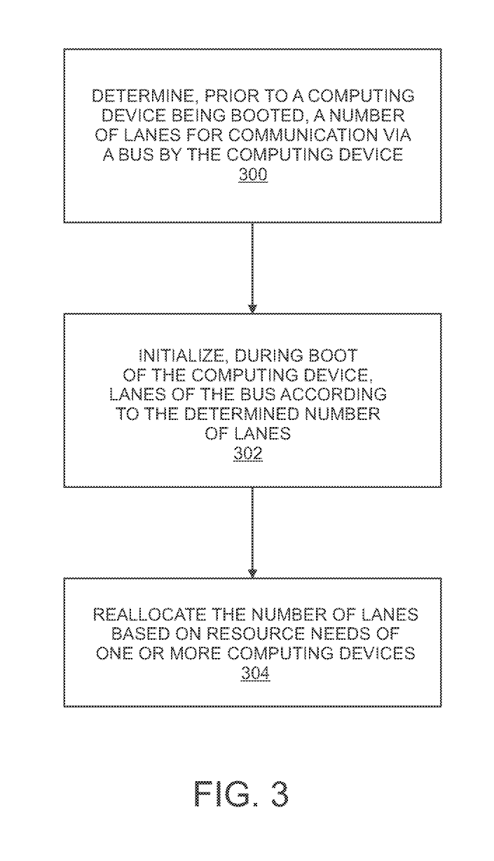

FIG. 3 illustrates an example flow chart of an example method for initializing computing device bus lanes during boot in accordance with embodiments of the present disclosure. The example method is described in reference to FIG. 2, but it should be understood that the method may be implemented on any computing device having a bus with lanes. Also, the method is described as being implemented by a resource allocation module on a BMC, but it should be understood that the method may be suitably implemented by any component(s) residing on a computing device.

Referring to FIG. 3, the method includes determining 300, prior to a computing device being booted, a number of lanes for communication via a bus by the computing device. For example, the resource allocation module 102 shown in FIG. 1 may determine, prior to the server 104 being booted, a number of lanes for communication by the expansion bus 116. The lanes for communication may be between the processor(s) 108 and another component of the server 104. As an example, FIG. 2 shows lanes 202 of the bus 200 connecting the processor 204 and the component 206. The resource allocation module 102 may determine the number of lanes for connecting the processor 204 and the component 206.

In an example, the resource allocation module 102 may determine the numbers of lanes as being the maximum number of lanes needed for communication between the components, such as the processor 204 and the component 206 shown in FIG. 2. In this example, four lanes are determined to be needed. It is noted that for a particular system, the maximum number of lanes may be known to the BMC, as the BMC may be aware of the physical layout of the system (i.e., how many lanes each PCIe connector may have installed). This information may also be learned during initial system boot if there were configuration details which the system BIOS uses to setup the system.

The method of FIG. 3 includes initializing 302, during boot of the computing device, lanes of the bus according to the determined number of lanes. Continuing the aforementioned example, the resource allocation module 102 shown in FIG. 1 may initialize the lanes of the bus according to the determined number of lanes. In an example, the resource allocation module 102 may initialize the maximum number of lanes determined to be needed for communication between the components, such as the processor 204 and the component 206 shown in FIG. 2.

The method of FIG. 3 includes reallocating the number of lanes based on resource needs of one or more computing device components. Continuing the aforementioned example, the resource allocation module 102 may monitor for changing resource needs of the component 206 shown in FIG. 2. For example, the traffic rate needed for the component 206 may increase. In response to determining that the traffic rate increases, the resource allocation module 102 may add lanes allocated between the processor 204 and the component 206. Conversely, the traffic rate needed for the component 206 may decrease. In response to determining that the traffic rate decreases, the resource allocation module 102 may remove lanes allocated between the processor 204 and the component 206.

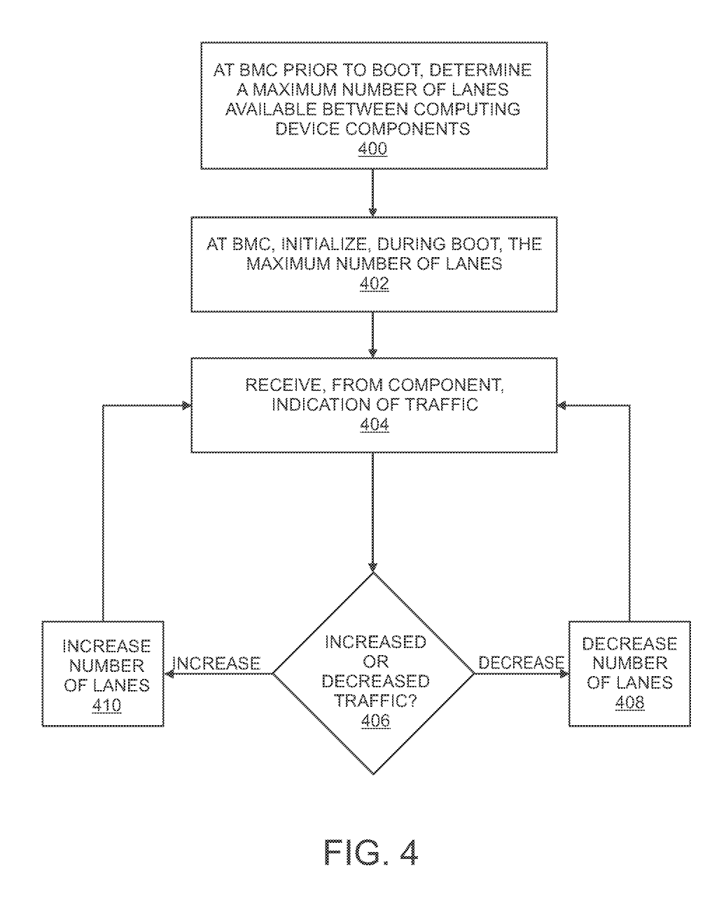

FIG. 4 illustrates a flow chart of another example method for initializing computing device bus lanes during boot in accordance with embodiments of the present disclosure. The example method of FIG. 4 is described in reference to FIG. 2, but it should be understood that the method may be implemented on any computing device having a bus with lanes. Also, the method of FIG. 4 is described as being implemented by a resource allocation module on a BMC, but it should be understood that the method may be suitably implemented by any component(s) residing on a computing device.

Referring to FIG. 4, the method includes determining 400, at a BMC and prior to boot of the computing device of the BMC, a maximum number of lanes available between computing components of the computing device. For example, the resource allocation module 102 of the BMC 106 shown in FIG. 1 may determine a maximum number of lanes available between the processor(s) 108 and the data storage 120 via the expansion bus 116.

The method of FIG. 4 also includes initializing 402, at the BMC and during boot, the determined maximum number of lanes available. Continuing the aforementioned example, the resource allocation module 102 of the BMC 106 shown in FIG. 1 may initialize the determined number of lanes available on the example bus 116 for the processor(s) 108 and the data storage 120.

With continuing reference to FIG. 4, the method includes receiving 404, from a component, indication of traffic. Continuing the aforementioned example, the resource allocation module 102 of the BMC 106 shown in FIG. 1 may receive an indication from the data storage 120 of a change in its communication traffic with the processor(s) 108. For example, the traffic may increase above a predetermined level over a predetermined time period. In another example, the traffic may decrease below a predetermined level over a predetermined time period. More generally, the resource allocation module 102 may determine an activity level increasing or decreasing for the component for use in determining whether to increase or decrease the number of lanes as described in more detail herein. In examples, the resource allocation module 120 may alter lanes allocated based on traffic pattern usage. Another example includes determining how much power is being consumed, and limiting the number of lanes to remain under a predetermined power level. In another example, devices may have other mechanisms in place to throttle for power capping.

The method of FIG. 3 includes determining 406 whether traffic increased or decreased. Continuing the aforementioned example, in response to the resource allocation module 102 determining a decrease below the predetermined level over the predetermined time period, the number of lanes may be decreased (block 408). Conversely at block 406, in response to the resource allocation module 102 determining an increase above the predetermined level over the predetermined time period, the number of lanes may be increased (block 410). A method to control the physical connection/de-connection of the lanes between components may be used. This may either be provided at one (or both) endpoints of the connection, but may require specific support from the endpoint to enable/disable lanes based on an input from the resource allocation module. Another example approach may be where the lanes between the components pass through a device that could provide a gate to either connect or disconnect the lane based on direct input from the resource allocation device. This may not need direct support from the endpoints (since a device in the middle is controlling the # of lanes available). In both cases, the endpoints may still be responsible for rebalancing the traffic across all lanes available which depending on the endpoint may require a reset to other re-initialization of the device (this would also be controlled by the resource allocation device). More generally, the resource allocation module 102 may increase or decrease the number of lanes based on an increase or decrease, respectively, of activity level over a predetermined period of time.

In accordance with embodiments, the resource allocation module may control a minimum or maximum number of lanes available between computing device components. The minimum may be 1 lane, and the maximum number may be based on the physical structure of the system (as mentioned in previous comments). The resource allocation device may monitor traffic usage by collecting information from the endpoints (for example gathering statistics from the device to determine traffic rates).

In an example use scenario, the presently disclosed subject matter may be used in RAID applications. In this example, at boot all of its supported lanes may be initialized. If only low demand storage requests are being made, the resource allocation module may deactivate unneeded lanes. The deactivated lanes may be subsequently reactivated if a large read or write operation is started. The lanes may be deactivated again when the operation is completed.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
at a processing module configured to operate when a computing device is not booted:
determining, prior to the computing device being booted, a number of lanes for communication via a bus by the computing device; and
during boot of the computing device, initializing the lanes of the bus according to the determined number of lanes.

2. The method of claim 1, wherein the processing module comprises a baseboard management controller (BMC).

3. The method of claim 1, wherein determining the number of lanes comprises determining a maximum number of lanes.

4. The method of claim 1, further comprising:
determining whether an activity level of communication on the bus is below a predetermined threshold; and
in response to determining that the activity level is below the predetermined threshold, deactivating one or more initialized lanes.

5. The method of claim 4, wherein determining whether the activity level of communication is below the predetermined threshold and deactivating is implemented at the processing module.

6. The method of claim 4, wherein determining whether the activity level of communication on the bus is below the predetermined threshold comprises determining whether the activity level of communication on the bus is below the predetermined threshold for a predetermined time period, and
deactivating the one or more initialized lanes in response to determining that the activity level of communication on the bus is below the predetermined threshold for the predetermined time period.

7. The method of claim 4, wherein determining whether the activity level of communication on the bus is below the predetermined threshold comprises determining whether the activity level of communication on the bus is below the predetermined threshold for a predetermined time period, and
deactivating the one or more initialized lanes in response to determining that the activity level of communication on the bus is below the predetermined threshold for the predetermined time period.

8. The method of claim 7, wherein the activity level comprises a rate of traffic.

9. The method of claim 4, further comprising:
determining whether an activity level of communication on the bus is above the predetermined threshold; and
in response to determining that the activity level is above the predetermined threshold, activating the one or more initialized lanes.

10. The method of claim 9, wherein determining whether the activity level of communication is above the predetermined threshold and activating is implemented at the processing module.

11. The method of claim 9, wherein determining whether the activity level of communication on the bus is above the predetermined threshold comprises determining whether the activity level of communication on the bus is above the predetermined threshold for a predetermined time period, and
activating the one or more initialized lanes in response to determining that the activity level of communication on the bus is activating the predetermined threshold for the predetermined time period.

12. The method of claim 9, wherein the activity level comprises a rate of traffic.

13. The method of claim 1, wherein the lanes are part of a peripheral component interconnect (PCIe) redundant array of independent disks (RAID) device.

14. The method of claim 13, further comprising:
determining whether storage requests are below a predetermined threshold; and
in response to determining that the storage requests are below the predetermined threshold, deactivating one or more initialized lanes.

15. The method of claim 14, further comprising:
determining whether a read or write operation is started that is above a predetermined amount; and
in response to determining that the read or write operation is started, activating the one or more initialized lanes.

16. A system comprising:
a processing module configured to operate when a computing device is not booted, and the processing module configured to:
determine, prior to the computing device being booted, a number of lanes for communication via a bus by the computing device; and
initialize the lanes of the bus according to the determined number of lanes during boot of the computing device.

17. The system of claim 16, wherein the processing module comprises a baseboard management controller (BMC).

18. The system of claim 16, wherein the processing module is configured to determine the number of lanes comprises determining a maximum number of lanes.

19. The system of claim 16, wherein the processing module is further configured to:
determine whether an activity level of communication on the bus is below a predetermined threshold; and
deactivate one or more initialized lanes in response to determining that the activity level is below the predetermined threshold.

20. The system of claim 16, wherein the processing module is further configured to:
determine whether an activity level of communication on the bus is above the predetermined threshold; and
activate the one or more initialized lanes in response to determining that the activity level is above the predetermined threshold.
